(19) United States
(12) Patent Application Publication
(10) Pub. No.: US 2010/0313842 A1
(43) Pub. Date: Dec. 16, 2010

(54) CORROSION RESISTANT INSERT FOR A CYLINDER HEAD

(75) Inventors: Guangling Song, Troy, MI (US); Blair E. Carlson, Ann Arbor, MI (US); Dale A. Gerard, Bloomfield Hills, MI (US); Ping-Ho Tsai, Troy, MI (US); Johnnie M. Williams, Clarkston, MI (US); Pui-Kei Yuen, Rochester Hills, MI (US); David L. Moore, Madison Heights, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/685,193

(22) Filed: Jan. 11, 2010

Related U.S. Application Data
(60) Provisional application No. 61/186,952, filed on Jun. 15, 2009.

(51) Int. Cl. F02F 1/24; B23P 11/00

(52) U.S. Cl. 123/193.5; 29/888.01

(57) ABSTRACT

An engine includes a cylinder head at least partially defining a valve seat pocket. A valve seat is located proximate to the cylinder head to at lest partially define the valve seat pocket. A pocket filler is located between the valve seat and the pocket insert such that the pocket filler occupies a substantial portion of the valve seat pocket. A pocket insert is attached to the cylinder head proximate to the valve seat pocket, such that the pocket insert lines at least a portion of the valve seat pocket.

### CROSS-REFERENCE TO RELATED APPLICATIONS

This application claims the benefit of and priority to United States Provisional Patent Application No. 61/186,952, filed Jun. 15, 2009, which is hereby incorporated by reference in its entirety.

### TECHNICAL FIELD

The present invention relates, generally, to an engine, and more specifically, to an arrangement for preventing corrosion of the cylinder head.

### BACKGROUND OF THE INVENTION

Cylinder heads commonly include valve seats to provide a seating surface for the engine valves. The valve seats are typically inserts that are positioned within the cylinder head. Valve seats are typically manufactured from materials that are wear-resistant and heat-resistant. Often the valve seat is manufactured from a different material than the cylinder head. For example, aluminum engine cylinder heads commonly have steel valve seats.

### SUMMARY OF THE INVENTION

An engine includes a cylinder head at least partially defining a valve seat pocket. A valve seat is located proximate to the cylinder head to at least partially define the valve seat pocket. A pocket filler is located between the valve seat and the pocket insert such that the pocket filler occupies a substantial portion of the valve seat pocket.

A method for mitigating corrosion within an engine includes placing a valve seat proximate to a cylinder head such that the valve seat and the cylinder head at least partially define a valve seat pocket. A pocket insert is attached to the cylinder head proximate to the valve seat pocket, such that the pocket insert lines at least a portion of the valve seat pocket. A pocket filler is then assembled between the valve seat and the pocket insert such that the pocket filler occupies a substantial portion of the valve seat pocket.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional illustration of an engine showing an cylinder head and valve seat.

### DESCRIPTION OF THE PREFERRED EMBODIMENTS

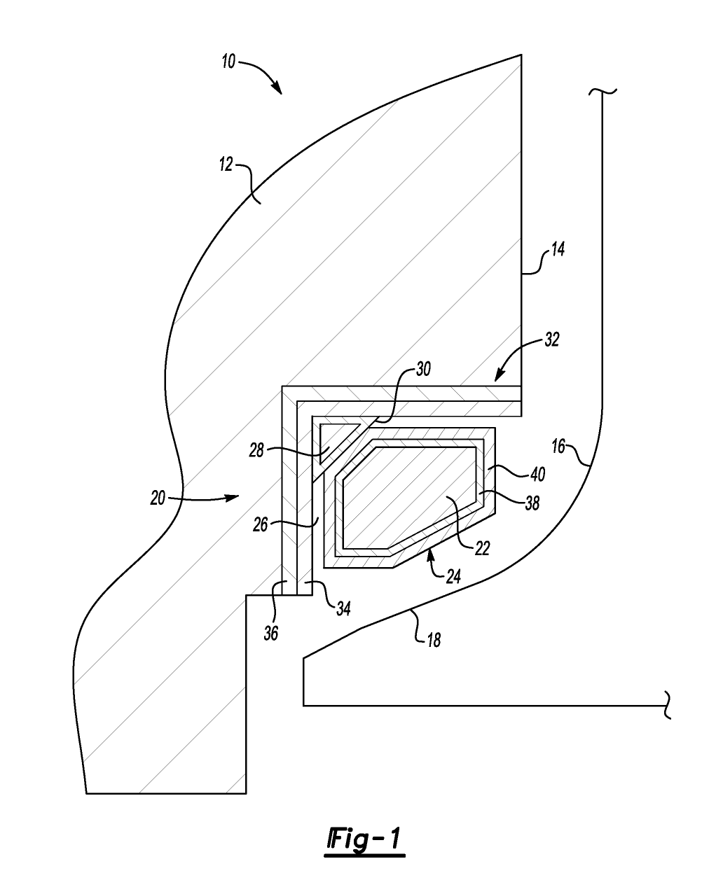

Referring to the FIGURE, wherein like reference numbers refer to the same or similar components throughout the several views, FIG. 1 schematically illustrates an engine 10 having a cylinder head 12 defining a valve opening 14. A valve 16 is located within the valve opening 14 and includes a valve head 18. The cylinder head 12 also defines a stepped portion 20 for aligning a valve seat 22. The cylinder head 12 is preferably an aluminum alloy and the valve seat 22 is preferably a steel alloy. The valve seat 22 is positioned to provide a seating surface 24 for the valve head 18 during operation of the engine 10.

Positioning the valve seat 22 adjacent to the stepped portion 20 defines a valve seat pocket 26 located between the valve seat 22 and the cylinder head 12. A valve seat pocket filler 28 is located within the valve seat pocket 26 to fill at least a substantial portion of the valve seat pocket 26. The valve seat pocket filler 28 is formed in the general shape of the valve seat pocket 22 and manufactured from a material that inhibits corrosion of aluminum. Alternatively, the valve seat pocket filler 28 may have a common shape, such as an O-ring having a circular cross-sectional shape.

The valve seat pocket filler 28 is preferably a rubber-based material which is chemically stable and may be formed from an elastic material to accommodate movement of the valve seat 22 relative to the cylinder head 12. For example, the valve seat pocket filler 28 may be a fluorelastomer such as Viton®, or may be Teflon® or phenolic materials.

The valve seat pocket filler 28 may be larger than the valve seat pocket 22 such that the valve seat pocket filler 28 is under compression when the valve head 18 is resting on the valve seat 22. The valve seat pocket filler 28 substantially occupies the area of the valve seat pocket 26 to prevent the valve seat pocket 26 from filling with engine fuel. Therefore, the valve seat pocket filler 28 prevents fuel from becoming trapped in the valve seat pocket 26 and prevents corrosion of the cylinder head 12 that may result when the engine fuel is a bio-fuel and the cylinder head 12 is formed of an aluminum alloy. The valve seat pocket filler 28 may also be bonded in place to assist the valve seat pocket filler 28 in filling the valve seat pocket stepped portion 20.

The valve seat pocket filler 28 may also have a coating 30 of material applied to the surface which is known to have an inhibiting effect on the corrosion of aluminum. For example, the material for the coating 30 may be colloids such as tragacanth, acacia, agar-agar, glue, dextrin, or gelatin. Additional materials known to have an inhibiting effect on the corrosion of aluminum may also be mixed with the colloids for the coating 30 of the valve seat pocket filler 28. For example, aldehydes, sebacic axis, phenyl semicarbazide derivatives, amines, cerium dibuytlphosphates, citric acid, azodyes, anion, pyridine, surfactants, Vernonia amygdalina, Halide ions, 2-acetylphenothiazine, methyl red, TSC (Thiosemicarbazone), Lawsonia extract (Henna, aqueous extract of Rosmarinus officinalis L, methylene blue, Hibiscus subdariffa (Karkode) extract, molasses, caffeine, 4-(2′-amino-5′-methylphenylazo) antipyrine, Zenthoxylum alatum plant, extract of the leaves of Nypa fruticans (Wurmb), or vanadates may be mixed with the colloids to form the coating 30. Therefore, the valve seat pocket filler 28 may release inhibitors to prevent corrosion of the engine bock head 12 proximate to the valve seat pocket 26.

A pocket insert 32 may also be secured to the cylinder head 12 at the stepped portion 20. The pocket insert 32 provides a liner for the cylinder head 12 along the stepped portion 20 and assists in preventing corrosion of the valve seat 22 and the cylinder head 12 adjacent the valve seat pocket 26. In one embodiment, the pocket insert 32 is a steel insert that is preformed and secured to the cylinder head 12 at the stepped portion 20 during casting of the cylinder head 12. That is, the pocket insert 32 may be placed in the mold for the cylinder head 12 such that the cylinder head 12 is formed around the pocket insert 32 during casting.

The pocket insert 32 may also include a first layer 34 formed of a first material and a second layer 36 formed of a second material. The first and the second materials may be selected to increase the corrosion protection of the cylinder head 12 at the valve seat pocket 26. The first layer 34 may be adjacent the valve seat 22 and the second layer 36 may be adjacent the cylinder head 12. Alternately, the second layer 36 may be a cladding applied around the first layer 36. In either of these embodiments, the first layer 34 may be steel to assist in preventing corrosion and the second layer may be aluminum to improve the bond that forms between the cylinder head 12 and the pocket insert 32 during casting of the cylinder head 12. Alternately, there may be tabs located on the pocket insert 32 to mechanically bond the pocket insert 32 to the cylinder head 12 during casting of the cylinder head 12.

The valve seat pocket filler 28 can be secured to the valve seat 22 or to the cylinder head 12 by attachment to the pocket insert 32. Adhesive material may be used to secure the valve seat pocket filler 28 to the valve seat 22 or the pocket insert 32.

The valve seat 22 includes a first valve seat coating 38. The first valve seat coating 38 is preferably a ceramic coating. The first valve seat coating 38 may be created by applying an aluminum coating to the surface of the valve seat 22 such as by an Alumiplate™ technique, as is known to those skilled in the art. The aluminum coating is then converted into a ceramic coating such as through an electro-deposition technique like Anodine EC2™, as is known to those skilled in the art. The resulting first valve seat coating 38 has high corrosion resistance and high wear resistance. By first applying an aluminum coating and then converting the aluminum to ceramic, there is a higher level of adhesion between the first valve seat 22 and the first valve seat coating 38. The valve seat coating 38 prevents fretting wear on the valve seat 22 during operation of the engine 10

The valve seat 22 may also include a second valve seat coating 40. The second valve seat coating 40 may be a material applied to the surface of the first valve seat coating 38, which is known to have an inhibiting effect on the corrosion of aluminum. For example, aldehydes, sebacic axis, phenyl semicarbazide derivatives, amines, cerium dibuytlphosphates, citric acid, azodyes, anion, pyridine, surfactants, or vanadates, etc. may be mixed with the a base material to form the second valve seat coating 40. The base material for the second valve seat coating 40 may be a hard material such as ceramic. Alternatively, the inhibitor may be directly incorporated into the first valve seat coating 38. The second valve seat coating 40 may be formed about the entire circumference of the valve seat 22, as shown, or may be applied to areas where the inhibitor may have the most effect, such as adjacent to the valve seat pocket 26. Therefore, the valve seat pocket seat 22 may release inhibitors to prevent corrosion of the engine bock head 12 proximate to the valve seat pocket 26.

In the embodiment described above, the valve seat pocket filler 28, the pocket insert 30, first the valve seat coating 38, and the second valve seat coating 40 are all used within the engine 10. However, each of these elements may be utilized individually or in combination with one another to promote resistance to corrosion within the engine 10.

While the best modes for carrying out the invention have been described in detail, those familiar with the art to which this invention relates will recognize various alternative designs and embodiments for practicing the invention within the scope of the appended claims.

1. A method for mitigating corrosion within an engine comprising:
placing a valve seat proximate to a cylinder head such that the valve seat and the cylinder head at least partially define a valve seat pocket, wherein the valve seat includes a valve seat coating;
attaching a pocket insert to the cylinder head proximate to the valve seat pocket, such that the pocket insert is located in at least a portion of the valve seat pocket; and
assembling a pocket filler between the valve seat and the pocket insert such that the pocket filler occupies a substantial portion of the valve seat pocket.

2. The method of claim 1, wherein assembling the pocket filler further comprise attaching the pocket filler to one of the valve seat and the pocket insert.

3. The method of claim 1, further comprising applying a second coating to the valve seat prior to placing the valve seat within the engine cylinder head.

4. The method of claim 3, wherein the second coating releases at least one of a corrosion inhibitor and a corrosion passivator to prevent corrosion of the valve seat and the cylinder head.

5. The method of claim 1, wherein the pocket filler releases at least one of a corrosion inhibitor and a corrosion passivator to prevent corrosion of the valve seat and the cylinder head.

6. The method of claim 1, wherein the valve seat coating prevents at least one of fretting and corrosion to the valve seat.

7. The method of claim 1, wherein the attaching the pocket insert to the engine cylinder head further includes securing the pocket insert into position during casting of the cylinder head.

8. An engine comprising:
a cylinder head at least partially defining a valve seat pocket;
a valve seat located proximate to the cylinder head to at least partially define the valve seat pocket; and
a pocket filler located between the valve seat and the pocket insert such that the pocket filler occupies at least a portion of the valve seat pocket.

9. The engine of claim 8, wherein the pocket filler is secured to one of the valve seat and the pocket insert.

10. The engine of claim 8, further comprising a first valve seat coating on the valve seat.

11. The engine of claim 10, wherein the first valve seat coating is a ceramic coating to prevent at least one of fretting and corrosion to the valve seat.

12. The engine of claim 10, further comprising a second valve seat coating on the valve seat.

13. The engine of claim 12, wherein the second valve seat coating includes at least one of a corrosion inhibitor or a corrosion passivator to prevent corrosion of the valve seat and the cylinder head.

16. The engine of claim 8, wherein the pocket filler includes at least one of a fluorelastomer, Viton®, Teflon®, and a phenolic material.

17. The engine of claim 8, wherein the pocket filler includes a coating having at least one of a corrosion inhibitor and a corrosion passivator to prevent corrosion of the valve seat and the cylinder head.

18. The engine of claim 17, wherein the pocket filler coating includes at least one of tragacanth, acacia, agar-agar, glue, dextrin, gelatin, aldehyde, sebacic acid, phenyl semicarbazide derivative, amine, cerium dibuytlphosphate, citric acid, azodye, anion, pyridine, surfactant, Vernonia amygdalina, Halide ions, 2-acetylphenothiazine, methyl red, TSC (Thiosemicarbazone), Lawsonia extract (Henna), aqueous extract of Rosmarinus officinalis L, methylene blue, Hibiscus subdariffa (Karkode) extract, molasses, caffeine, 4-(2′-amino-5′-methylphenylazo) antipyrine, Zenthoxylum alatum plant, extract of the leaves of Nypa fruticans (Wurmb), and vanadate.

19. The engine of claim 8, further comprising a pocket insert secured to the cylinder head proximate to the valve seat pocket, such that the pocket insert lines at least a portion of the valve seat pocket.

20. The engine of claim 19, wherein the pocket insert is cast in position on the cylinder head.
